(19) United States
(12) Patent Application Publication
(10) Pub. No.: US 2021/0237499 A1
(43) Pub. Date: Aug. 5, 2021

(54) METHOD FOR PRODUCING A SECURITY ELEMENT HAVING TWO SECURITY FEATURES AND USE OF THE METHOD

(71) Applicants: Covestro Deutschland AG, Leverkusen (DE); Covestro Intellectual Property GmbH & Co. KG, Leverkusen (DE)

(72) Inventors: Oliver Muth, Berlin (DE); Olga Kulikovska, Berlin (DE); Tatjana Sauer, Berlin (DE); Jörg Fischer, Berlin (DE); Arthur Mathea, Berlin (DE); Franziska Peinze, Berlin (DE); Enrico Orselli, Köln (DE); Thomas Rölle, Leverkusen (DE); Wieland Hovestadt, Leichlingen (DE); Heinz Pudleiner, Krefeld (DE); Dennis Hönel, Zülpich-Wichterich (DE)

(73) Assignees: Covestro Deutschland AG, Leverkusen (DE); Covestro Intellectual Property GmbH & Co. KG, Leverkusen (DE)

(21) Appl. No.: 17/053,953

(22) PCT Filed: May 9, 2019
(86) PCT No.: PCT/EP2019/061901

§ 371 Date: Nov. 9, 2020

(30) Foreign Application Priority Data
May 9, 2018 (DE) 10 2018 207 251.5

(51) Int. Cl. B42D 25/29; B42D 25/328; B42D 25/337; B42D 25/382; B42D 25/387

(52) U.S. Cl. CPC B42D 25/29; B42D 25/328; B42D 25/387; B42D 25/382; B42D 25/337

(57) ABSTRACT

To simplify the production of a security element 300 with a first security feature 310 and a second security feature 320, the following method is proposed: (a) Provision of a light-sensitive film 200, which comprises at least one carrier layer 210 and in surface-to-surface contact with this a light-sensitive function layer 220; (b) Exposure of the light-sensitive film 200 at least area by area, with the formation of a pattern in the light-sensitive function layer 220, wherein the security element (300) is formed with a first security feature (310); (b′) Optional fixing of the exposed light-sensitive film; and (c) Printing of the carrier layer 210 and, as appropriate, of the protective layer 230, wherein a second security feature 320 is produced.

### BACKGROUND OF THE INVENTION

### 1. Field of the Invention

The invention relates to the field of value documents or security documents and methods for their production.

### 2. Prior Art and Background of the Invention

Methods for producing value documents or security documents are well known. These serve the purpose of verifying the identity of a person, for example when crossing a national border, or the identity of an item, or a claim, for example for the payment of a sum of money, or for the issue of a product, or the provision of a service. In this situation it is to be ensured that the document cannot be imitated, counterfeited, or falsified, or only with substantial effort. The document therefore contains security features, the reproduction of which is extremely difficult or even practically impossible. For example, the document, such as a bank note, consists of a material which is not readily available. In addition or as an alternative, security features can be formed by special inks, such as luminescent or optically variable inks, optical elements, such as holograms, tilting pictures, kinegraphic objects, lens or prism arrays, as well as guillochs, mixed fibre, security threads, and others. It is also a requirement that the value documents or security documents can be produced easily and reliably.

For example, optical security features can be produced separately in the form of security elements, and can then be adhesively bonded as patches, layers, security threads, security strips, or the like, onto an outer surface on the value document or security document, or onto an inner surface inside the Value document or security document, and in the latter case can then be integrated into the document, Such security elements can be optically variable elements, such that visually perceptible displays which are thereby produced are either identifiable or not identifiable depending on the angle at which the value document or security document is viewed, and/or can assume a different general appearance. For example, from DE 10 2009 007 552 A1 it derives that value documents or security documents can be provided with a security feature which is produced by holographic means, in particular volume holographic means.

DE 10 2009 007 552 A1 discloses a method for producing multilayered security products, which consist of at least one card and at least one polymer film, applied onto at least one side of the card, wherein the polymer film is provided as roll material, and is provided with at least one security feature. For this purpose, a roll web of the polymer film, and at least one strip with an n-times number of copies, are conveyed to a laminating station and laminated. Before the lamination, a control line is arranged on the polymer film, which is assigned to the at least one security feature which is to be applied onto the respective copy, or a control line assigned to the copy or to the strip and/or the reference mark are assessed. The delivery conveying speed and/or a conveying direction are adjusted to one another in relation to the roll web of the polymer film and to the strip in order to attain exact alignment. The roll web of the polymer film can be individualised, and can, for example, contain holograms.

For example, for the production of identity documents which comprise individualising holograms or other optical diffraction elements, the optical diffraction elements are accordingly first provided in the form of roll material, wherein a roll contains a plurality of optical diffraction elements. After the preparation of all the optical diffraction elements of a roll, they are connected to the blanks of the identity documents to which they are assigned. Since this plurality of optical diffraction elements which are located on such a roll, and which define a production batch, can only undergo further processing when all the optical diffraction elements of this roll have been completed, there is a considerable delay in the production sequence for those optical diffraction elements on the roll which were produced first. From this the problem arises that the time required for the production of a value document or security document is substantially also determined by the period of time which is required for the production of all the security elements on the web material of a roll of security elements.

To solve this problem, in DE 10 2015 210 522 A1 a method is proposed for producing a multilayer value document or security document which is formed at least by a polymer base layer and a security element laminated onto that. This method comprises the following method steps: (a) provision of polymer base material in the form of polymer base material comprising polymer base layer copies, with single or multiple copies; (b) provision of a web material in roll format, provided for the production of a plurality of security element copies; (c) production of the security element copies on and/or in the web material; (d) merging and stacking in each case of a polymer base material single or multiple copy and of security element copies onto one another, such that in each case one polymer base layer copy and one security element copy lie in precise register on one another; and (e) surface-to-surface connection of the respective polymer base layer copies and the security element copies with one another, wherein security material single or multiple copies, which comprise one or more security element copies, are individually taken from the web material present in the roll format, and then the security material single or multiple copies are processed in the method steps (d) and (e).

Further, in DE 10 2015 226 604 A1 a method is described for integrating a hologram into a security document body, which comprises a lamination body. The method comprises the steps: Provisions of a hologram film with a carrier substrate layer and a photo layer; provision of further substrate layers, and carrying out of a lamination for the formation of the lamination body. The hologram film is merged with the further substrate layers to form one substrate layer stack, and then merged together with the further substrate layers in a lamination process to form the lamination body.

The invention is based on the following objects:

If it is intended that, in addition to a hologram, which, for example, individualises the holder of the document, with these known methods, an individualising security feature produced by printing is also to be integrated into the value document or security document, for example into a passport or an identity card, the problem arises that these two security features must be arranged correctly in relation to one another when the document is produced, in order for them to be integrated into the same document. This requires a painstaking management of all the data required for the production of a document, and careful data management in order to bring together the correct hologram with the correct unfinished card body, which already contains a personalising print. If this is not successful in every case, the document which is produced must be thrown away. This assignment arrangement requires a substantial logistical effort during the production of such documents, with the result that production is elaborate and complex, as well as excessively large with regard to equipment, and is nevertheless still prone to errors. From DE 10 2015 226 604 A1, for example, it is derived that the further substrate layers used for the production of the document can exhibit printed impressions. Likewise, in DE 10 2015 210 522 A1 it is mentioned that the card formats used for the production of the documents can already be individualised by means of the image of a face, which can be produced with the aid of a printing process. A further disadvantage of these methods lies in the fact that the processes are very long, with the result that the effort in the production of the documents is substantial.

A further disadvantage is the fact that the hologram must be applied onto the unfinished card body as an over-format, and individual copies are thereafter produced by a punch, whereupon it is only then possible for errored copies to be extracted from the production process.

The present invention is therefore based on the object of providing measures in the production of value documents or security documents with which, in particular, production of documents which is prone to error and excessively elaborate can be avoided.

### SUMMARY OF THE INVENTION

The present invention relates to a method for producing a security element with two security features. The invention is based on a method which comprises the following method steps: (a) provision of a light-sensitive film, comprising a light-sensitive film, consisting of at least one carrier layer and, in surface contact with that, a light-sensitive function layer, as well as, optionally, a protective layer on the side of the light-sensitive function layer located opposite the carrier layer; (b) Illumination exposure of the light-sensitive film with a pattern; and (b′) optional fixing of the exposed light-sensitive film, with the forming of a security element with a security feature. The present invention further relates to the use of a method for producing a value document or security document.

### BRIEF DESCRIPTION OF THE DRAWING FIGURES

A more detailed explanation of the invention is provided by the figures and examples explained hereinafter, wherein these serve only to illustrate specific embodiments, but do not represent any limitation on the scope of the invention. These show, in detail:

FIG. 1 An isometric view of a value document or security document produced by the method according to the invention;

FIG. 2: a reproduction of the method steps of the method according to the invention in a first embodiment, by way of a schematic representation of the processed semi-finished product, at different process stages, in cross-section: (A) Provision of the light-sensitive film; (B) Exposing and, as appropriate, fixing of the film, with the formation of the security element with the first security feature; (C) Printing of the film, with the formation of the security element with the first and the second security feature; (D) Bringing together of the security element and of the polymer layers, with the formation of a layer stack (in the form of an exploded view); (E) Lamination of the layer stack, with the formation of a value document or security document;

FIG. 3: a reproduction of a part of the method steps of the method according to the invention, in a second embodiment, by way of a schematic representation of the processed semi-finished product at different process stages, in cross-section: (C) Printing on both sides of the film, with the formation of the security element with the first and the second security features; (D) Bringing together of the security element and of the polymer layers, with the formation of a layer stack (in the form of an exploded view); (E) Lamination of the layer stack, with the formation of a value document or security document;

FIG. 4: a reproduction of a part of the method steps of the method according to the invention, in a third embodiment, by way of a schematic representation of the processed semi-finished product at different process stages, in cross-section: (D) Bringing together of the security element and an unfinished card body, with the formation of a layer stack (in the form of an exploded view); (E) Lamination of the layer stack, with the formation of a value document or security document;

FIG. 5: a reproduction of a part of the method steps of the method according to the invention, in a fourth embodiment, by way of a schematic representation of the processed semi-finished product at different process stages, in cross-section: (D) Bringing together of the security element and the polymer layers, with the formation of a layer stack (with electric circuit; in the form of an exploded view); (E) Lamination of the layer stack, with the formation of a value document or security document comprising an electric circuit;

FIG. 6 a reproduction of a part of the method steps of the method according to the invention, in a fifth embodiment, by way of a schematic representation of the processed semi-finished product at different process stages, in cross-section: (A) Provision of the light-sensitive film (without protective layer); (BI) Exposing and, as appropriate, fixing of the film with the formation of the security element with the first security feature; (BII) Laminating of the composite structure onto a protective layer provided as carrier; (BIII) Drawing off the protective layer.

### DETAILED DESCRIPTION OF THE INVENTION

### Definitions

Inasmuch as the term ‘value document or security document’ is used in the Description and in the claims of the present application, this is to be understood, for example, among other items as being a passport, personal identity card, driving licence, an access control document or another form of ID card, a vehicle certificate, a vehicle logbook, a visa, a cheque, a means of payment, in particular a bank note, a cheque card, a bank card, a credit card or cash payment card, a customer card, health card, chip card, a company identity card, authorisation ID, a membership card, a gift or purchase credit certificate, a freight note, or another form of authorisation ID, revenue stamp, postage stamp, ticket, token, or some other form of document. The value document or security document can, for example, also be a Smartcard. The value document or security document can be provided in ID 1-, ID 2-, ID 3-, or in any other standardised or non-standardised format, for example in the form of a booklet, such as an item resembling a passport, or, for example, in card form. A value document or security document is in general a laminate of several document layers, which are connected to one another surface to surface in precise register under the effect of heat and under increased pressure. Value documents or security documents should satisfy the standardised requirements, for example in accordance with ISO 10373, ISO/IEC 7810, ISO 14443, in the respective version applicable at the filing date of this application.

The value document or security document layers consist preferably of a polymer material, which is suitable for lamination, and which provides the document with the required mechanical and chemical properties. The value document or security document can be formed from one or more polymers, which are selected from a group consisting of polycarbonate (PC), in particular bisphenol A-polycarbonate, polyethylene terephthalate (PET), its derivates, such as glycol-modified PET (PETG), polyethylene naphthalate (PEN), polyvinylchloride (PVC), polyvinyl butyral (PVB), polymethylmethacrylate (PMMA), polyimide (PI), polyvinyl alcohol (PVA), polystyrene (PS), polyvinyl phenol (PVP), polypropylene (PP), polyethylene (PE), thermoplastic elastomers (TPE), in particular thermoplastic polyurethane (TPU), acrylonitrile-butadiene-styrene copolymer (ABS) and their derivatives, or paper or card or glass or metal or ceramics. Preferably, it consists of PC or PC/TPU/PC. The polymers can be present either filled or unfilled. In the latter case, they are preferably transparent or translucent. If the polymers are filled, they are opaque. Preferably, the document is produced from 3 to 12, and for particular preference 4 to 10 films. The films can also carry print layers.

Inasmuch as use is made in the description and in the claims of the terms ‘individualising’, ‘individualised’, ‘personalising’ and ‘personalised’, this is to be understood to mean that the security feature or security element to which the respective term relates differentiates one value document or security document from another value document or security document, and the value document or security document is assigned to a specific entity (in the case of the terms ‘individualising’ or ‘individualised’), in particular to a specific person (in the case of the term ‘personalising’ or ‘personalised’). Instead of a person, the value document or security document can also be assigned to an object, such as a motor vehicle, a sale product, or a value paper. By means of the individualising or personalising, a third party can recognise the unambiguous assignment of the value document or security document to the entity or to groups of the same or similar type.

Inasmuch as use is made in the description and in the claims of the present application of the term ‘hologram’, this is to be understood as an item of holographic information which is stored in a light-sensitive photopolymer layer, which can be reconstructed by means of irradiation with electromagnetic radiation of a suitable wavelength and direction. Stored in the light-sensitive function layer of the light-sensitive film are interference structures, which represent the hologram. This can be formed, for example, by local refraction index variations.

Inasmuch as use is made in the description and in the claims of the present application of the term light-sensitive function layer', this is to be understood as a layer into which preferably a refractive optical structure can be stored by means of an illumination exposure process, or, after the illumination and, as appropriate, after a fixing of the hologram. As an alternative, it is also possible for a photograph, or a representation motif produced in some other manner, to be produced in the light-sensitive function layer. In the non-exposed state, such a layer can contain, for example, a three-dimensional cross-linked photopolymer.

Inasmuch as use is made in the description and in the claims of the present application of the term ‘pattern’, this is to be understood as a refractive structure formed in a volume region and/or on the surface of a material, or a distribution of elements, formed in some other manner, which produce an optical impression for the human eye. In the latter case, the element distribution is to be understood preferably as a two-dimensional arrangement of light-absorbing locations on one or more (outer or inner) planes on and/or in the document, which produce an inherently closed representation, for example a picture, picture element, a character or sign, in particular an alphanumeric sign, a symbol, coat of arms, decor, logo, ornament, motive, a line, a formula, a drawing, a simple geometric shape, or the like. In the meaning of the present invention, a visible pattern can be formed in only one colour, including black, white, and/or grey, or in several colours. The pattern can form an individualising or non-individualising characterising marking.

Inasmuch as use is made in the description and in the claims of the present application of the term ‘security element, this is to be understood both as a piece of material with one or more security features, which can be further processed to a single value document or security document (individual copy), as well as a piece of material from which, by way of individualisation, a plurality of value documents or security documents can be produced (multiple copies). For example, a security element in the form of an individual copy can also be understood to be a piece of material which does not yet have the end format of the value document or security document which is to be obtained from it. The latter can be produced from this by cutting. The security element may, if appropriate, also not yet exhibit all the features of the complete value document or security document, which should contain further additional security features.

Inasmuch as use is made in the description and in the claims of the present application of the term ‘laminate’ and ‘lamination’ are used, this is to be understood to mean the surface-to-surface connection of at least two workpieces containing polymer material, for example of at least two polymer films, to one another under the effect of pressure and heat during a predetermined period of time, wherein no additional adhesive material is used between the two layers which are to be connected. Typically, by the softening or liquefying of the layer materials due to the reaching of the glass transition temperature of the polymer material, a monolithic composition of the two connection partners is created, i.e. a division line between the two materials in a completed cross-section is no longer identifiable, inasmuch as materials are in contact which are not different from one another, and/or foreign constituent parts, such as a printing ink, are present in the region of the bordering surfaces, which mark the boundary surface.

Inasmuch as use is made in the description and in the claims of the present application of the term ‘protective layer’ is used, this is to be understood as a layer which may be used, if appropriate, to produce the security element, together with the carrier layer, the function layer and, as appropriate, also further layers. The protective layer is used to protect a Value document or security document towards the outside against damage or other impairing influences, if the security element is connected by an outwards facing protective layer to the other components of the document. As well as this, the protective layer protects the light-sensitive or exposed film during the processing, i.e. before a connection to the other components of the document, against damage and other impairing influences of the function layer.

Inasmuch as use is made in the description and in the claims of the present application of the term ‘film’, this is understood to mean a surface-extended object, consisting of one or more material layers in surface-to-surface contact and connected to one another, wherein the film exhibits an almost uniform material thickness transverse to the surface extension, which is clearly less, in particular by one or more orders of size, than the extension of the film in a direction in the plane of the surface extension of the film.

Inasmuch as use is made in the description and in the claims of the present application of the term ‘light-sensitive film’, this is to be understood as a film which comprises, as at least one material layer, a one-layered or multi-layered carrier layer and, as a further material layer, a light-sensitive function layer, which is in direct surface-to-surface contact with the carrier layer, wherein the light-sensitive function layer covers the carrier layer full-surface on one side. If the light-sensitive film additionally comprises a protective layer, which will be or is applied on the side opposite the carrier layer of the light-sensitive function layer, then the protective layer like-wise covers the function layer full-surface. The light-sensitive film therefore exhibits the same structure in relation to the carrier layer and the function layer at every position of the light-sensitive film. If the light-sensitive film also comprises a protective layer, then this applies in relation to the carrier layer, the function layer, and the protective layer, i.e. the light-sensitive film exhibits the same structure in relation to the carrier layer, the function layer, and the protective layer at each position of the light-sensitive film.

Basic features of the invention and preferred embodiments:

The present invention is based on the recognition that it is advantageous to provide a first security feature, formed in a light-sensitive film, and a second security feature formed by printing, not in production processes which are carried out independently of one another, but instead in the same production process. Accordingly, first a semi-finished product is produced, in which, for example, a hologram, in particular a volume hologram, and for particular preference a holographic image, and the printing, for example a photograph, are combined. This results, on the one hand, in an arrangement of individualising first and second security features being rendered possible in the same value document or security document without any problems, while this is not the case with conventional production methods without further actions. This semi-finished product can then be merged with polymer films or other polymer bodies to form a document body, in particular by means of lamination. Following this, an individual copy (security element) can be individually produced from the semi-finished product, for example by punching out.

This means that the individual processes required hitherto can be done away with, namely the application of a hologram or of another security feature produced by means of the light-sensitive film and the punching out of individual copies after the hologram application.

The objects referred to heretofore, and on which the invention is based, are solved by a method for producing a security element with two security features. The method comprises the following method steps:
(a) provision of a light-sensitive film; the light-sensitive film comprises at least one carrier layer and, in surface-to-surface contact with this, one light-sensitive function layer, as well as, if appropriate, a protective layer on the side of the light-sensitive function layer opposite the carrier layer; if appropriate, the light-sensitive film can additionally comprise one or more further layers (layers/films);
(b) exposing of the light-sensitive film at least in regions, with the formation of a pattern in the light-sensitive function layer, wherein the security element is formed with a first security feature; the exposed region can be smaller than the format of the light-sensitive film; in particular, the exposed region can also be smaller than the format which the light-sensitive film adopts on/in a value document or security document;
(b′) optional fixing of the exposed light-sensitive film;
   If the film, exposed and, if appropriate, fixed, does not yet comprise a protective layer, such a layer can be applied, preferably after method step (b) or (b′) and preferably before method step (c), onto the side of the function layer opposite the carrier layer;
   and
(c) printing of the carrier layer on the side opposite the function layer, wherein a second security feature is produced.

By contrast with the method according to the invention, in known processes a hologram, after its production on a pre-product form of the value document or security document, which is produced from polymer layers by lamination and which additionally exhibits one or more printed features, is laminated on, i.e. as described in DE 10 2015 210 522 A1, adhesively bonded by means of an adhesive. As an alternative, in known processes the hologram, after its production, is merged with polymer layers, which are additionally provided with one or more printed features, to form a stack, and is connected to these by lamination (DE 10 2015 226 604 A1).

Due to the fact that the printed (second) security feature, according to the invention, is formed in the same substrate (the security element) as the (first) security feature, formed, for example, as a (volume) hologram, the production of these two security features can be initiated practically in parallel, such that security elements are introduced in two individualising planes in one single formation process into the value document or security document. This has the advantage that first and second individualising security features for a predetermined security document can be assigned to one another without any problems. As a result, the possibility of errored arrangement can be largely excluded, so that defective documents due to such errored arrangements are not produced. Moreover, the two security features can be produced practically simultaneously, since they are created in/on the same substrate. This makes a shortened process possible, with the advantage that only a relatively small production system is required. With conventional methods, conversely, the two features are produced in/on different substrates, which are typically formed in sequential processes, such that a perceptibly longer production must be taken into account.

Provision is preferably made for the foregoing method steps to be carried out in the sequence indicated, wherein, as appropriate, at least one further method step can be provided between individual method steps, several method steps, or all the method step pairs following one another in sequence, in the sequence arrangement described heretofore. Accordingly, method step (c) (printing of the carrier layer), in a preferred embodiment, is to be carried out after the performance of the method step (b) (exposing of the light-sensitive film) or, as appropriate, after the carrying out of the optional method step (b′) (fixing of the exposed light-sensitive film), or, as appropriate, between method step (b) and the optional method step (b′). Moreover, it is also possible for other method steps to be carried out between the method steps (b), (b′) and (c), such as the laminating on of another layer, for example a protective layer, or the cutting of the security element material, or the individual production of several security elements from the security element material. As an alternative, however, the printing (method step (c)) can also be carried out before the exposing of the light-sensitive film (method step (b)).

In a further preferred embodiment of the present invention, the light-sensitive film is a holography film. It has proved to be particularly advantageous for full-surface security elements to be integrated into the value documents or security documents, for example in the form of refractive optical elements, in particular of holograms. For example, German personal identity documents and the pass cards of German passports contain, beneath the mark, a full-surface hologram, known as an identigram, integrated into which are a number of different diffractive optical security features, among them in each case at least one volume reflection hologram.

In a further preferred embodiment of the present invention, the first security feature can preferably be a volume hologram. Instead of a volume hologram, it is also possible for any other refractive optical security element, or another security feature, to be produced in the light-sensitive film. As refractive optical elements it is possible, for example, for holograms to be formed, in particular reflection holograms, kinegraphic holograms, or volume holograms, or also diffractive structures, such as blaze structures, linear diffraction gratings, crossed diffraction gratings, hexagonal gratings, asymmetrical or symmetrical grating structures, or diffraction structures.

The first security feature can preferably be individualising, and for greater preference personalising. The second security feature can also preferably be individualising, and for greater preference personalising. Preferably, at least one of the two security features can also be machine-readable.

The carrier layer of the light-sensitive film is a substrate layer, which preferably is mechanically self-supporting and with which the light-sensitive function layer is in contact. The carrier layer can in particular be formed from or more of the materials from which the layers of the value document or security document can be formed. Preferably, the carrier layer is formed from polycarbonate, for preference on the basis of bisphenol A.

In a further preferred embodiment of the present invention, the protective layer of the light-sensitive film is configured in the form of a scratch protective layer. During the production of the value document or security document, the carrier layer can remain in the document, or can subsequently be removed. Preferably, the protective layer is formed from polycarbonate, for particular preference from polycarbonate on the basis of bisphenol A. As an alternative, a protective layer formed from polyethylene terephthalate is also possible. Conceivable and advantageous is a radiation-hardening protective layer, in particular which can be hardened by means of UV radiation. The material of the protective layer is preferably formed from a material on the basis of an optional thermoplastic binder, of one or more radiation-hardenable monomers, preferably selected from the group of monofunctional or oligofunctional acrylates or methacrylates, as well as from one or more UV-initiators and/or further additives or ancillary substances. The protective layer can be provided with an additional protective film.

Accordingly, the light-sensitive film preferably formed by a material which comprises a single-layer or multi-layer carrier layer (thickness typically 20 μm to 200 μm, preferably 35 μm to 100 μm, for particular preference 50 μm±5 μm), a light-sensitive function layer (thickness typically 2 μm to 25 μm, preferably 5 μm to 20 μm, for particular preference 15 μm±3 μm) and, as appropriate, a protective layer (thickness typically 5 μm to 50 μm, preferably 7 μm to 30 μm, for particular preference 8 μm to 20 μm). These layers are preferably formed by materials which are conventionally provided for value documents or security documents, in particular polymer materials, and for particular preference are present in the form of films/layers, namely in the form of the carrier film, the light-sensitive function layer, and the protective layer. For this purpose, use is made for the light-sensitive function layer of a conventional light-sensitive material, such as a photopolymer, preferably on a polyurethane base (see, for example, WO 2014/029717 A1; express reference is made in this situation to the disclosure of this document in respect of the prior art, at least in respect of the composition of the photopolymer described therein; to this extent, this disclosure is adopted into the present application), a silver halide layer, dichromate gelatine, or another photographic material suitable for the production of refractive optical elements, in particular for volume holography. The light-sensitive film can be formed, for example, by a commercially available film. Advantageous is a high temperature-stable photopolymer. Such photopolymers are described, for example, in WO 2011/054797 A and in WO 2011/067057 A, and consist preferably of a material on the basis of three-dimensional cross-linked binders, preferably polyurethane, containing light-sensitive components and writing chemicals (content substances in a matrix of photopolymers) into which bright holograms can be written by the holographic illumination, followed by a bleaching step. At least in respect of the composition and of the manufacturing process of the photopolymer, reference is expressly made to the disclosure of this document in respect of the prior art, which is adopted into the present application.

In a particularly preferred embodiment of the present invention, the light-sensitive film is produced by a method which is described, for example, in WO 2009/056111 A1. Express reference is made to the disclosure of this document in respect of the prior art, at least with regard to the manufacturing method of the light-sensitive film, which is adopted into the present application. According to this embodiment, the light-sensitive film, which is present in the form of a composite with at least one first polymer layer (carrier layer) and a second polymer layer (protective layer), is produced in each case from a polycarbonate polymer on the basis of bisphenol A, wherein the light-sensitive function layer is arranged between the polymer layers. The method comprises the following method steps: (a) The light-sensitive function layer is arranged on the carrier layer; (b) the carrier layer is coated on the side on or in which the light-sensitive function layer is arranged, at least in the region of the function layer, with a fluid preparation containing a solvent agent or a solvent agent mixture, as well as a polycarbonate derivative on the basis of a geminal disubstituted dihydroxydiphenyl cycloalkane; (c) optionally, method step (b) is followed by a drying process step, preferably at elevated temperature, in particular in the range from 20° C. to 120° C., during a predetermined drying time, preferably from 1 min to 600 min; (d) following on from method step (b) or method step (c), the protective layer is laid onto the sandwich formed from the light-sensitive function layer and the carrier layer, wherein the light-sensitive function layer is covered; (e) the sandwich which is formed is laminated under pressure, for example 10 N/cm² to 100 N/cm², at elevated temperature, for example in the range from 120° C. to 220° C., and during a defined period of time, for example from 0.5 s to 45 min, in particular 10 min to 30 min. The polycarbonate derivatives which can be used, on the basis of a geminal disubstituted dihydroxydiphenyl cycloalkane, and their production process, are described, for example (in the form of a binding agent for screen-printing inks) in EP 0 688 839 A2. Reference is expressly made to the disclosure of this document in respect of the prior art, at least in respect of the composition of the preparation described therein, and very particularly in respect of the composition of the binding agent described therein, and the production of the components of this binding agent and of the binding agent itself. To this extent, this disclosure is adopted into the present application. The polycarbonate derivative preferably has a mean molecular weight (mean weight) of at least 10,000 g/Mol, preferably 20,000 to 300,000 g/Mol.

Refractive optical elements are produced in the light-sensitive film by illumination (method step (b)) and, as appropriate, by fixing (method step (b′)). For producing a refractive optical structure, or another pattern as a security feature, an exposure device is used (optionally with a fixing device), which is configured by a processing device for exposing and, as appropriate, for fixing the light-sensitive film so as to form the structure or the pattern in the film. In order to produce a hologram, the light-sensitive film is holographically exposed in a known manner. One method which can be used for this is described, for example, in EP 0 896 260 A2. Reference is expressly made to the disclosure of this document in respect of the prior art, at least in respect of this method, which is adopted into the present application. For this method step an illuminator is used. The function material can then be fixed. In particular, heat can be applied (radiation energy in the infrared range). For this purpose an oven or an infrared section is used. As an alternative, electromagnetic radiation in the visible or UV spectral range can also be used in order to fix the function material. Devices for carrying out the fixing step are known and are commercially available.

In a preferred embodiment of the present invention, the light-sensitive film is exposed but not yet provided as fixed. In such a case, first a film is provided which comprises the light-sensitive function layer and the carrier layer and can be laminated onto the one hardenable film as a protective layer, before the printing of the film on the side of the function layer, i.e. either already after the illumination (method step (b)) and, as appropriate, before the fixing (method step (b′)) or, as appropriate, only after the fixing, but in any event before the printing (method step (c)). A hardenable protective layer is in this case a surface-formed layer, which, by the application of energy, can be modified in respect of its chemical and/or physical structure in such a way that it exhibits greater strength after the application of energy. For particular preference, the hardening and fixing are put into effect by way of irradiation with ultraviolet (UV) radiation. In particular, such a layer comprises prepolymers, monomers and/or oligomers, or polymers which, by the effect of energy, can give rise to a higher polymerisation stage and/or to cross-linking.

Since the photopolymer is typically, due to its chemical nature, sensitive to external influences (such as air humidity, elevated temperature, chemicals, light), such that the properties of a holographic grating which has been formed may be lost or damaged, it is advantageous for the optional protective layer to be laminated onto the light-sensitive function layer in a drying process. For this purpose a protective layer supported by a carrier can be used, which is laminated onto the film formed from photopolymer and carrier layer, and, after the hardening of the protective layer, bonds more strongly to the photopolymer than to the carrier, such that the carrier can subsequently be drawn off and the protective layer remains on the photopolymer. For this purpose, a carrier is preferably used made from a material on the basis of polyethylene. For the protective layer a material can be used which has been referred to heretofore for the radiation-hardenable protective layer.

In a further preferred embodiment of the present invention, a refractive optical feature (first security feature) is formed by a (volume) hologram of the picture of the face of the holder of the document. For particular preference, a volume reflection hologram is exposed into the light-sensitive function layer, which will be or is produced, for example, as an individualised contact copy from a hologram master. The individualisation takes place by a spatial modulation of the light used for the copying.

In a preferred embodiment of the present invention, the carrier layer is printed in method step (c). It is true that the protective layer can also be printed in this method step. This form of printing, however, is disadvantageous due to the lesser thickness of the protective layer (see below).

For producing the print as a second security feature of the security element, any desired printing ink can be used, and printing with any desired printing method. Nevertheless, according to a further preferred embodiment of the present invention, it is preferred that a printing ink be used for the printing of the carrier layer or, as appropriate, of the protective layer, with a binding agent formed on the basis of a polycarbonate, produced for particular preference on the basis of a geminal disubstituted dihydroxydiphenyl cycloalkane with one or more polyols. Printing inks which contain such a binding agent are known from DE 10 2007 052 947 A1. Reference is expressly made to the disclosure of this document in respect of the prior art, at least in respect of the composition of the preparation described therein, and very particularly in respect of the composition of the binding agent described therein, and the production of the components of this binding agent. To this extent, this disclosure is adopted into the present application. By the use of this printing ink, the printing on the security element can be carried out with a large surface proportion, without the problem arising of a separation layer due to the printing ink, which would lead to the possibility that the value document or security document could become separated between the security element and the at least one polymer film. For example, with this printing ink it is therefore possible for a surface printing to be produced, such as a surface printing which leaves a window free (and otherwise continuous).

The printing ink can, in the conventional manner, contain colouring agents (dyes, pigments), wherein dyes are to be preferred in relation to pigments, since they diffuse more easily into the materials of the security element and of the at least one polymer film, such that the checking of the value document or security document for any tampering is made possible due to the fact that, in the event of any tampering by way of replacement of the security element, residues of the printing would remain in the at least one polymer film.

As the colouring agent, in principal any desired colouring agent or colouring agent mixtures come into consideration. ‘Colouring agents’ are understood to be all substances which produce colours. This means that this may involve dyes (an overview of dyes is provided in Ullmann's Encyclopedia of Industrial Chemistry, Electronic Release 2007, Wiley Verlag, chapter on “Dyes, General Survey”) as well as pigments (an overview of organic and inorganic pigments is provided in Ullmann's Encyclopedia of Industrial Chemistry, Electronic Release 2007, Wiley Verlag, chapter on “Pigments, Organic” and “Pigments, Inorganic” respectively).

The colouring agents can absorb electromagnetic radiation in the visible (VIS) spectral range, and in this way can have an effect on the visual recognition of the printing with the naked human eye. Also conceivable are colouring agents which absorb the electromagnetic radiation in another spectral range than the visible spectral range, namely in the ultraviolet (UV) spectral range spectral range and/or in the infrared (IR) spectral range, as appropriate, in addition to the visible spectral range. In addition, printing inks can also be used of which the colouring agents are photoluminescing agents or contain these agents, wherein these agents either fluoresce or phosphoresce when they are excited by electromagnetic radiation, for example with UV, VIS, and/or IR radiation. Also conceivable are electroluminescing agents. The luminescence can lie in the VIS, IR, and/or UV spectral ranges. In a typical application situation of photoluminescing agents, these are excited by UV or IR radiation, and luminesce in the visible spectral range. The colouring agents can, in addition to an absorption in the VIS spectral range, also luminesce in particular in the VIS spectral range. Also conceivable, in addition to an absorption in the VIS spectral range, is a luminescence in the IR and/or UV spectral range. As an alternative, the colouring agents can luminesce exclusively, but not also absorb in the VIS spectral range.

In addition to this, colouring agents in the form of optically variable pigments are possible. Such pigments typically show interference colours, in that they are present in thin layers. Such pigments are obtainable, for example, from Merck AG, DE, under the trade name Iriodin®. Also conceivable are printing inks which contain cholesteric liquid crystal pigments or ferromagnetic pigments.

The printing inks can, for example, also be machine-readable if they contain the colouring agents referred to heretofore.

For printing by means of ink-jet printing, colouring agents must have, in addition to an adequate temperature stability, in particular the finest possible particle size distribution. In practice, this means that the particle size should not exceed 1.0 μm, since otherwise this will result in blockages in the printing head. As a rule, nanoscale solid-body pigments and colouring agents in solution have proved their worth.

For the production of the printing, suitable colouring agents can be cationic, anionic, or also neutral. Simply as examples of colouring agents which can be used, mention may be made of: Brilliant black C.I. No. 28440, Chromogen black C.I. No. 14645, Direct deep black E C.I. No. 30235, Authentic black salt B C.I. No. 37245, Authentic black salt K C.I. No. 37190, Sudan black HB C.I. 26150, Naphtol black C.I. No. 20470, Bayscript® Black liquid, C.I. Basic Black 11, C.I. Basic Blue 154, Cartasol® Turquoise K-ZL liquid, Cartasol® Turquoise K-RL liquid (C.I. Basic Blue 140), Cartasol Blue K5R liquid. Also suitable are, for example, the commercially available colouring agents Hostafine® Black TS liquid (marketed by Clariant GmbH Germany), Bayscript® Black liquid (C.I. Mixture, marketed by Lanxess), Cartasol® Black MG liquid (C.I. Basic Black 11, trademark of Clariant GmbH Germany), Flexonyl®black PR 100 (E C.I. No. 30235, marketed by Clariant), Rhodamin B, Cartasol® Orange K3 GL, Cartasol® Yellow K4 GL, Cartasol® K GL, or Cartasol® Red K-3B. In addition, use can also be made, as soluble colouring agents, of anthrachinon, azo, chinophthalone, cumarin, methine, perinone, and/or pyrazole colouring agents, available, for example, under the brand name Macrolex®. Further suitable colouring agents are described in the literature reference of Ullmann's Encyclopedia of Industrial Chemistry, Electronic Release 2007, Wiley Verlag, chapter “Colorants Used in Ink Jet Inks”. Readily soluble colouring agents lead to an optimum integration into the matrix and the binding agent of the print layer respectively. As has been described heretofore, the binding agent can be formed in particular by a polycarbonate derivative on the basis of a geminal disubstituted dihydroxydiphenyl cycloalkane. Reference is made in this respect to DE 10 2007 052 947 A1. In this specification different variants of these derivatives and their production methods are described. Reference is expressly made to the disclosure of this document in respect of the prior art, and this is adopted into this present disclosure. The colouring agents can be introduced either directly as dyes or pigments, or as a paste, a mixture of dye and pigment together with a further binding agent. This additional binding agent should be chemically compatible with the further components of the preparation. With the use of what are referred to as brightly coloured pigments in the scale colours of Cyan-Magenta-Yellow, and preferably also (soot) Black, full-tone colour images are possible.

The second security feature can be realised with conventional printing techniques. In a preferred embodiment of the present invention, the printing can be produced with a digital printing method, for example, with an inkjet printing process, or with a xerography process (electro-photographic printing process). Also conceivable is a laser-engraving process. Due to their great flexibility, digital printing processes are particularly well-suited for producing individualising print images. As an alternative to a digital printing process, in the method according to the invention for producing the second security feature it is of course also possible for any other desired printing process to be used, for example a planographic printing, gravure printing, or screen printing process, in particular an offset, flexographic, or silk screen printing process.

By the formation of the first and the second security features, the security element can be individualised, in particular personalised.

In addition, the printing of the security element in a further preferred embodiment of the present invention is formed by a print of the picture of a face.

The two security features can be arranged in relation to one another in such a way that they overlap. This guarantees greater security against falsification.

In a further preferred embodiment of the present invention, after the performance of the method step (c), the following further method steps are carried out:

(d) Bringing together of the security element with at least one polymer layer to form a layer stack, and

(e) Lamination of the security element with the at least one polymer layer to form a value document or security document.

By bringing together and subsequent merging of the security element, comprising the first and second security features, with at least one polymer layer, a value document or security document is produced. This is due to the fact that, typically, the thickness of the security element is not sufficient to form a value document or security document. As well as this, with further polymer layers additional security features can be adopted into the document, for example non-individualising prints, such as a guilloche print, and/or an (integrated semiconductor) switching circuit for the storage, for example, of personally-related data or individualising prints, for example by laser engraving into one of the polymer films of recorded individualising information.

Preferably, the security element is brought together with the polymer layers and merged in such a way that it is in contact on one side with the polymer layer stack, i.e. it is arranged on the outside at the polymer layer stack.

In a preferred embodiment of the present invention it is also possible initially for a non-individualising unfinished document body (polymer layer), such as an unfinished card body, to be formed, in that this is produced, for example, by the laminating of several polymer films, and then individualising this with the security element, in that the security element is connected with this unfinished document body. In this way a large number of identical non-individualised unfinished document bodies can be produced in a central manufacturing facility, and, after transport to a decentral manufacturing facility, can be individualised there with the respective individualising security features of the corresponding security element. Preferably, however, the individualised security element is laminated with individual polymer films to form the corresponding value document or security document, without the polymer films being merged beforehand to form an unfinished document body.

For example, 2, 3, 4, 5, 6, 7, 8, 9, 10 or even more polymer layers can be used together with the security element. Preferably, 5 to 8, and for particular preference 6, polymer layers are used. The thickness of these layers can be chosen at will, and taking into consideration the requirements imposed on the value document or security document. For example, the thickness of the individual layers can amount to 20 μm to 500 μm, preferably 50 μm to 200 μm, and for particular preference 100 μm±10 μm. The polymer layers can be produced from the materials conventionally used for the production of value documents or security documents. Preferably, they are formed from polycarbonate and/or polyethylene terephthalate. For further preference, polycarbonate, and for particular preference polycarbonate on the basis of bisphenol A is used. All the polymer films can be produced from the same material or from different materials. If they are produced from the same material, a particularly high degree of adhesion between the layers is achieved. The polymer films can be printed, for example with further individualising or non-individualising, as appropriate machine-readable, security features and/or with flat surface print layers. In addition, windows can be taken out of the polymer layers, for example punched out. In addition, an inlay from a polymer film with a switching circuit made of a semiconductor chip and connection contacts and/or RFID antenna can be integrated into the document, in that this inlay is arranged between polymer layers in the stack which is to be connected.

The security element is preferably located on an outer side of the document. It is preferably connected to the polymer layers in such a way that, between the security element and the polymer film located at the side of the layer stack, facing towards the security element, there are no further layers, and also no adhesive layer. It is however conceivable that an adhesive layer is arranged between the security element and this polymer film. The latter case is in particular of interest if the security element is adhesively bonded onto an unfinished card body which has already been produced by laminating, for example as a patch, label, or the like, or also as a laminated element covering the entire surface of the unfinished card body. The security element can also be adhesively bonded onto a sale product in order to guarantee its authenticity.

The polymer layers can be transparent, translucent (allowing light to pass through) or opaque, wherein one, several, or none can be transparent, one, several, or none can be translucent, and one, several, or none can be opaque. If it is intended that an electrical circuit should be integrate into the polymer layer, it is preferable if the polymer layers adjacent to the electrical circuit are opaque, in order to screen the electrical circuit against being viewed from outside. This relates in particular to the polymer layer on which the electrical circuit is mounted (circuit carrier layer), and the polymer layer in contact with the electrical circuit. The outer polymer layers can be transparent, in order to keep the interior printings visible. Preferably, in addition to a protective layer in the form of a scratch protective layer on the security element, a further outer polymer layer can be formed as a scratch protection layer, and for this purpose can be formed from polyethylene terephthalate or polycarbonate or from another polymer suitable for this purpose, for example an acrylate polymer. This further outer polymer layer is, for further preference, that layer which is arranged on the (main) side (rear side), which is opposite the (main) side of the documents (front side) on which the security element is arranged. An inner polymer layer in the value document or security document can be provided with an individualising or non-individualising security print, for example with a guilloche print and/or with logos and/or with a card number and/or with general information about the place at which the card is being issued.

In a preferred further embodiment of the present invention, the carrier layer of the security element in the layer stack is in contact with the at least one polymer layer with which the security element is connected. Accordingly, the protective layer of the security element is located on one of the outer sides of the value document or security document. Due to the carrier layer being printed with the formation of the second security feature, the printing is arranged in the interior of the document. As a result, the printing is protected against tampering or manipulation.

In principle, however, it is also conceivable that the carrier layer is arranged on the outside of the document, i.e. that the protective layer is in contact at the at least one polymer layer, in particular if the protective layer is formed from polycarbonate. If in this case the carrier layer for the formation of the security feature is printed, this printing is exposed freely on the surface of the document. This is disadvantageous, however, since the printing can easily be manipulated due to its exposure. Inasmuch as the protective layer in this arrangement is arranged in the interior of the document, it can additionally be printed at the formation of the second security feature, in order for the printing to be arranged in the interior. Since the protective layer is usually very thin, a refractive optical element in the function layer could be impaired, at least at the points at which printed surface regions are located, i.e. in this case the printing influences the refractive optical element, such that the printing overlays the refractive optical element. Due to solvents in the printing ink, for example, the refractive grating which is formed can be extended, resulting in changes locally in the refraction conditions, This reduces the sharpness of the reconstructed image. In addition, this change can have an influence on the colours of the refractive optical image.

In a further preferred embodiment of the present invention, a polymer layer region in contact with the carrier layer of the value document or security document is formed from polycarbonate. In particular, the polymer layer which is in contact with the security element, i.e. is touching it, can be formed from polycarbonate. Due to the choice of this material for the polymer layer region in contact with the carrier layer, very good mechanical properties can be created in the value document or security document.

In a further preferred embodiment of the present invention, the carrier layer is formed from polycarbonate. Also due to the choice of polycarbonate for the carrier layer, very good mechanical properties are created in the value document or security document.

If both the document layer constituent parts referred to (carrier layer and the polymer layer regions in contact with it) are formed from polycarbonate, a very strong connection of the security element with the at least one polymer layer will be created.

The polymer layers can be formed from the conventional materials from which value documents or security documents are typically made. In principle, it is possible for not only the polymer layers which are directly in contact with the security element, but also other or all polymer layers in the layer stack are formed from polycarbonate, in particular from polycarbonate on the basis of bisphenol A.

The security element and the polymer layers or the unfinished document body are brought together in the usual manner to form a layer stack. For this purpose, these document constituent parts can be stacked on top of one another at a document stacking point, in a device suitable for this purpose, and then fixed to one another. In order to be brought together in an exact fit, the individual constituent parts are laid on one another preferably by means of register marks contained in them, such that they come to lie in exact register above one another. The constituent parts can be fixed to one another such as to be detachable or non-detachable: Either the constituent parts can be connected to one another for this purpose by spot welding, or mechanical means, such as clamps, are used, in order to connect the constituent parts in a layer stack securely to one another before they are finally and definitively merged.

In a preferred embodiment of the present invention, the security element and the at least one polymer layer or the unfinished document body are connected to one another by lamination (merged). Preferably, a conventional hot/cold lamination process is used, in which the fixed stack of the security element and the at least one polymer layer (or an already merged unfinished document body) are first pressed under increased pressure and increased temperature for a first predetermined period of time, and then, with the pressure increased, are cooled off and in this state are kept for a second predetermined period, if appropriate under still further increased pressure. The pressure in the hot press phase is preferably at least 20 N/cm², preferably in the range from 20 N/cm² to 100 N/cm². The temperature during the hot press phase lies preferably in the range from 150° C. to 20° C., and for further preference in the range from 160° C. to 195° C.

The product which is produced by lamination can finally be coated over at the side by a protective film, on which the security element is located. This film serves as further protection for the security element. A protective lacquer can be used, for example on the basis of an acrylate lacquer.

A value document or security document produced in accordance with the invention can comprise, in addition to the security features described, further security features, which are either individualising or non-individualising. As security features, consideration can be given, for example, to fibre mixes, guilloches, water marks, embossings, security threads, microscript, tilting images, transparent register marks, and the like. In addition, the document can also comprise electronic components, for example an RFID switching circuit antenna and RFID microchip, electronic display elements, LED's touch-sensitive sensors and the like. The electronic components can be arranged, for example, concealed between two opaque layers of the document.

In the Figures, the same reference numbers designate same elements or elements with the same function. The Figures do not in each case show the elements to scale with one another. Moreover, the size relationships of individual elements to those of others in a Figure or between the Figures are not in each case represented to scale with one another.

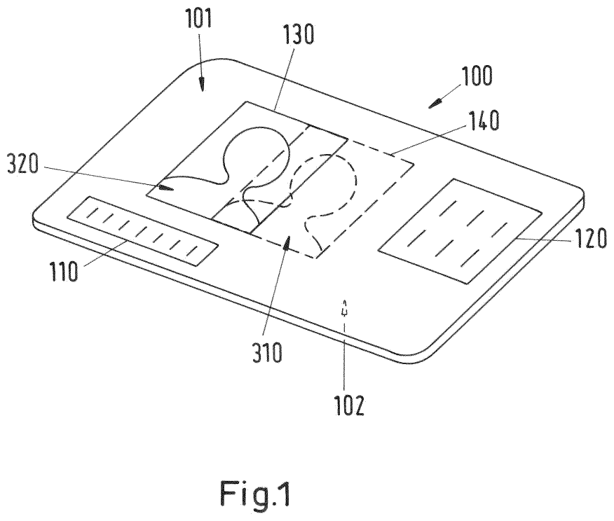

Represented in FIG. 1 is a value document or security document in the form of an identity card 100. The following description relates to an identity card, but can be transferred accordingly to any other value document or security document. The identity card exhibits conventional dimensions, for example the format ID 1 (ISO/IEC 7810 in the version applicable at the time of the application). The card is made of a rigid plastic, for example from polycarbonate and, as appropriate, partially also from polyethylene terephthalate. It comprises an upper side 101 and an under side 102. Visible on the upper side at two fields 110, 120, with personalising information items represented in an alphanumerical reproduction. These contain, for example, the name of the card holder, their date and place of birth and nationality, the date of issue, and a card number. The facsimile of the signature of the card holder can also be contained in this.

The picture of the face of the card holder can also be seen on the upper side 101, and specifically in the form of a printed photograph 130 and in the form of a volume hologram 140. Instead of the photograph and the volume hologram, other security features can also be used. The volume hologram forms a first security feature 310 and the printed photograph a second security feature 320. In addition, the volume hologram can also contain, in addition to the picture of the face, a (non-individualising) logo (not represented).

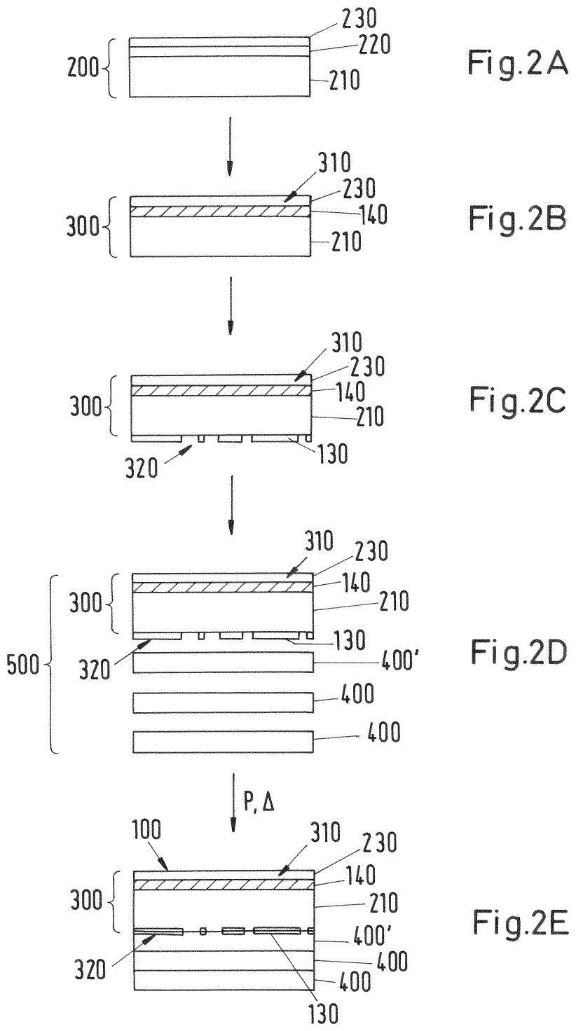

The method according to the invention is described by way of example on the basis of FIG. 2:

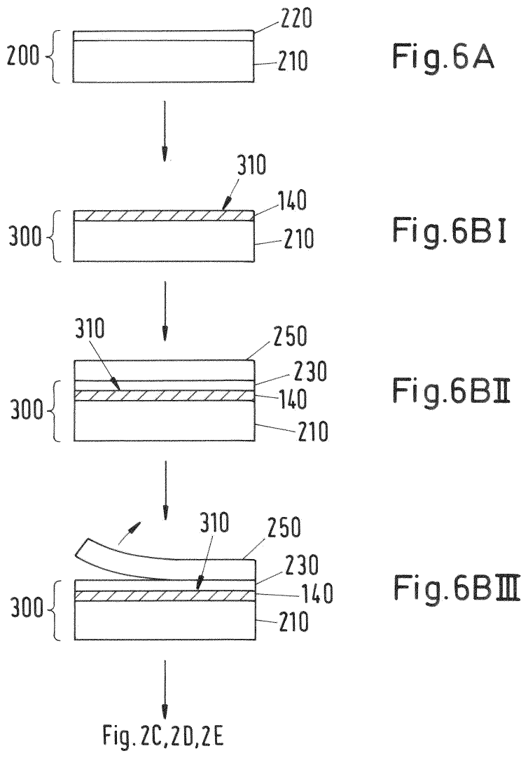

According to the first step (a) of the method according to the invention (FIG. 2A), a light-sensitive film 200 is provided. This is formed, for example, by a 50 μm thick carrier layer 210, in surface-to-surface contact with this a light-sensitive function layer 220, which can have, for example, a thickness of 15 μm, and a protective layer 230, which can have, for example, a thickness of 10 μm to 20 μm. As an alternative, the film can also be formed only from the carrier layer 210 and the light-sensitive function layer 220 (FIG. 6A). The carrier layer can preferably be formed from polycarbonate. The protective layer lies on the side of the light-sensitive function layer which is opposite the carrier layer. It can be formed, for example, from polycarbonate or polyethylene terephthalate or on the basis of an acrylate. The film is a conventional commercial holography film, which can be obtained from a number of different manufacturers. It can be present in the form of what may be referred to as a single copy, and in this case preferably over-dimensioned, if the format of the film is larger than the identity card for which this copy is intended. Preferably, the film is present in the form of a multiple-copy, namely, in particular, as web material, on which the holograms are produced in a row one after another, and from which they can be individually separated, for example by punching out.

According to the second step (b) of the method (FIG. 2B, 6BI), the light-sensitive film is exposed, with the formation of a security element 300, which comprises a first security feature 310 in the form of a volume hologram 140, and, as appropriate, is then fixed (method step (b′)). For this purpose the light-sensitive film, which is present preferably in the form of the web material, is delivered from a roll to an exposure device (optionally with a fixing device) (not represented). In the exposure device, the light-sensitive function layer 220 is exposed. In the fixing device the material is subjected to heat or electromagnetic radiation in the visible or UV-spectral range. The method of exposing and fixing is described in greater detail in EP 0 896 260 A2.

For example, a picture of the face of the card holder can be exposed, with the aid of a master hologram in form of a volume hologram 140, into the light-sensitive function layer 220. The methods suitable for the production of holograms, in particular volume holograms, are known, and can be carried out with devices suitable for this purpose. As appropriate, the latent refractive optical structure formed in the light-sensitive function layer is then fixed (method step (b′); FIG. 2B, 6BI). For this purpose, the light-sensitive film is subjected to electromagnetic radiation in the visible or UV-spectral range, or to heat. Such methods are likewise known to the person skilled in the art, and can be carried out with devices suitable for this purpose. During the performance of the method steps (b) and (b′), the refractive optical structure is formed in the light-sensitive function layer. Preferably this forms a hologram 140.

As an alternative to the production of a volume hologram 140, another pattern can also be formed in the light-sensitive function layer 220, for example another diffractive structure or a photographic imaging, which can be produced with a conventional photoreprographic process.

If the light-sensitive film 200 does not comprise a protective film 230 (FIG. 6A), this protective film is applied subsequently. In a preferred embodiment, the protective film can be provided in a composite assembly, in which the protective film is carried by a carrier 250, and is laminated onto the exposed and, as appropriate, fixed photopolymer layer 140. For this purpose, the layer stack which is formed is heated and subjected to pressure (FIG. 6BII). In a preferred embodiment, the protective layer is formed from a material which can be hardened by UV radiation, and which after the lamination is hardened by means of UV radiation (not separately represented). Following this, the carrier is drawn off, which is possible because the protective layer adheres more strongly to the layer 140 than to the carrier (FIG. 6BIII).

Next, the security element 300, provided with this first security feature 310, is printed in accordance with the third method step (c) of the method (FIG. 2C) (print layer 130), for example with the picture of the face of the card holder, such that a second security feature 320 is formed. As represented in FIG. 2C, in this embodiment the carrier layer 210 of the security element 300 is printed.

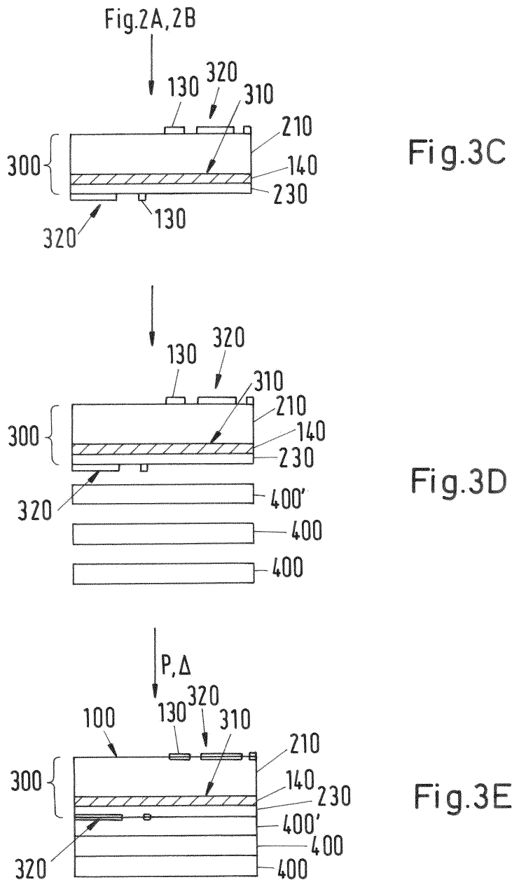

As an alternative, in addition to the carrier layer 210, the protective layer 230 can also be printed (see FIG. 3C). In this case, however, the volume hologram 140 could be impaired/influenced by the printing, at least at the points at which print regions of the printing are located.

For the printing of the security elements 300, preferably a digital printing process is used, for example an ink-jet printing process, in order to allow for adequate flexibility for the creation of an individualising print. It is particularly advantageous if a printing ink is used for the printing which has a composition on the basis of a polycarbonate, for example on the basis of a geminal disubstituted dihydroxydiphenyl cycloalkane. Such printing inks have the advantage that, under the effect of heat, they diffuse into the surface of a polymer layer 400′ and of the carrier layer 210 or protective layer 230 (FIG. 3E), such that the removal of the printing without leaving a trace is practically impossible.

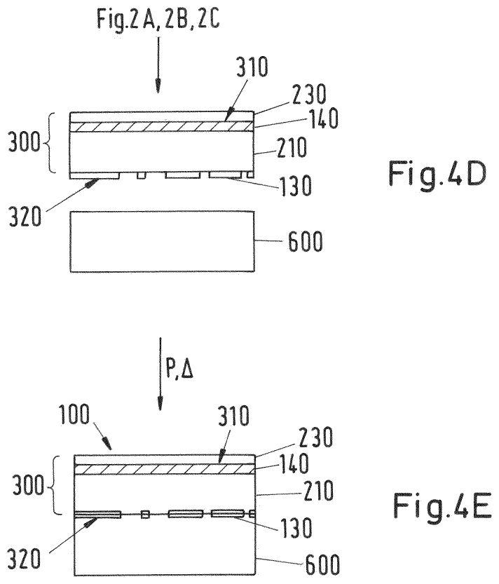

With the production of the first security feature 310 and of the second security feature 320 the present invention is already realised, since a security element 300 is thereby created which exhibits both the security features. The security element can, for example, be located onto an unfinished card body 600 (see FIG. 4D, 4E) and connected to this. In this embodiment, the preceding method steps (not shown) are identical to the steps shown in FIG. 2A, 2B, 2C.

In a particular preferred embodiment of the method according to the invention, the completed security element 300 is brought together with polymer layers 400, 400′ to form a layer stack 500, which are intended, together with the security element, to form the value document or security document 100 (FIG. 2D, 3D, 5D). These polymer layers can be produced from polymer materials which are conventional for the production of value documents or security documents. Preferably, use is made for this of polycarbonates and/or polyethylene terephthalate. It is particularly advantageous if a region of the polymer layers in contact with the carrier layer 210, preferably the polymer layer 400′ in contact with the carrier layer, is formed from polycarbonate. As a result, during the subsequent lamination a particularly high adherence of these polymer layers to the adjacent carrier layer is attained, in particular if the carrier layer is also produced from polycarbonate.

The same also applies accordingly for the situation in which it is not the carrier layer 210 which is in contact with the polymer layer 400′ but the protective layer 230 (FIG. 3D, 3E). In this embodiment, the preceding method steps for producing the security element 300 are identical to the steps shown in FIG. 2A, 2B. The security element produced in accordance with FIG. 2B is in this case, by contrast with the method step shown in FIG. 2C, for the further processing, in addition to the carrier layer 210, is also printed on the side of the protective layer (FIG. 3C). This side is then brought together with the polymer layers and laminated (FIG. 3D, 3E).

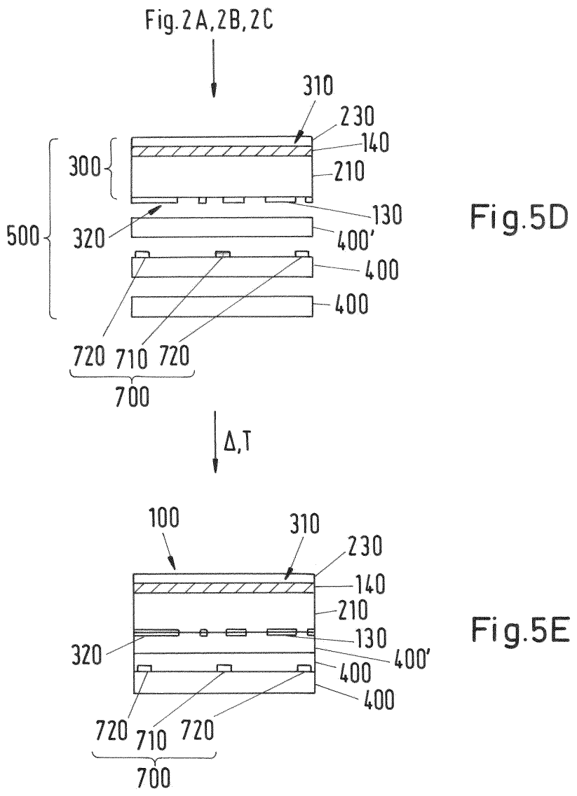

In a further preferred embodiment of the present invention, during the production of the identity card 100, an RFID circuit 700 or some other electrical circuit is integrated (FIG. 5D, 5E). In this embodiment, the preceding method steps for the production of the security element 300 are identical to the steps shown in FIG. 2A, 2B, 2C. For this purpose, one of the polymer layers 400 is provided with such a circuit. The circuit comprises an RFID semiconductor chip 710 and an electrical wiring arrangement in the form of an RFID antenna 720. The polymer layers on which the electrical circuit is arranged, as well as the further polymer layer 400′, in contact on this polymer layer on the side of the electrical circuit, are preferably opaque, so as to conceal the electrical circuit from the outside.

To merge the security element 300 with the polymer layers 400, 400′ or, respectively, with the unfinished card body 600, in the foregoing embodiments in accordance with FIGS. 2 to 6, after flat surface-to-surface stacking, these are brought into a laminating press, and there connected to one another under the application of high pressure (P), for example 20 N/cm² to 100 N/cm², and high temperature (a), for example at 180° C., in that the layers partially melt (FIG. 2E, 3E, 4E, 5E). These conditions are maintained for a predetermined period of time. At this stage, the printing ink has a tendency to diffuse into the layer regions of the adjacent connection partner elements. Due to subsequent cooling, while the pressure is maintained or even increased still further, the composite assembly which has formed becomes rigid, and forms a monolithic combination. Preferably, no boundary surfaces are identifiable any longer between the connection partner elements. Only in the region of the print layer 130 (second security feature 320) is this boundary surface marked by the printing ink.

Shown in FIG. 2E, 3E, 4E, 5E is the final state of the identity card 100 which has been produced: The boundary surfaces between the original layers 210, 230, 400, 400′ of the card 100 are drawn in only to illustrate the layers involved. Indicated in the region of the print layer 130 is the fact that the printing ink has diffused both into the carrier layer 210 (or protective layer 230), as well as into the polymer layer 400′ or the unfinished card body 600 respectively.

In the methods shown in FIGS. 2, 3, 4, 5 and 6, the security element 300, in one embodiment, can accommodate the entire surface of the identity card 100. In another embodiment, the security element can only accommodate a part surface of the identity card. In the latter case, it can, for example, be applied as a label or patch onto an unfinished card body 600 and connected to this.

### NUMBER LIST

100 Value document or security document, identity card

101 Upper side

102 Under side

110, 120 Information fields

130 Photography

140 Exposed and fixed function layer, (volume) hologram

200 Light-sensitive film

210 Carrier layer

220 Light-sensitive function layer

250 Carrier

230 Protective layer

300 Security element

310 First security feature

320 Second security feature

400, 400′ Polymer layers

500 Layer stack

600 Unfinished document body, unfinished card body

700 Electrical circuit, RFID circuit

710 Semiconductor chip, RFID chip

720 Electrical wiring arrangement, RFID antenna

1. A method for producing a security element, comprising the following method steps:
(a) providing a light-sensitive film, at least comprising at least one carrier layer and, in surface-to-surface contact with this, a light-sensitive function layer; and
(b) exposing the light-sensitive film at least region by region with the formation of a pattern in the light-sensitive function layer, wherein the security element is formed with a first security feature;
characterized in that the method additionally comprises the following method step:
(c) printing on the carrier layers, wherein a second security feature is produced.

2. The method according to claim 1, wherein, after method step (b), a protective layer is applied on the side of the light-sensitive function layer which is opposite the carrier layer.

3. The method according to claim 1, wherein the method additionally comprises the following method step: (b′) fixing of the exposed light-sensitive film, which is performed between the method steps (b) and (c).

4. The method according to claim 1, wherein the method additionally comprises the following method step: (b′) fixing the light-sensitive film, which is performed after the method steps (b) and (c).

5. The method according to claim 1, wherein the light-sensitive film is a holography film and the first security feature is a volume hologram.

6. The method according to claim 1, wherein, after carrying out of the method step (c), the following further method steps are carried out:
(d) bringing together of the security element with at least one polymer layer to form a layer stack, and
(e) laminating of the security element with the at least one polymer layer to form a value or security document.

7. The method according to claim 6, wherein the carrier layer of the security element in the layer stack is in contact with at least one polymer layer.

8. The method according to claim 6, wherein a polymer layer region in contact with the carrier layer of the value document or security document is formed from polycarbonate.

9. The method according to claim 1, wherein the carrier layer is formed from polycarbonate.

10. The method according to claim 1, wherein a printing ink used for the printing of the carrier layer is formed with a binding agent on the basis of a polycarbonate.

11. The method according to claim 10, wherein the polycarbonate of the printing ink is produced on the basis of a geminal disubstituted dihydroxydiphenyl cycloalkane with one or more polyols.

12. (canceled)

13. The method according to claim 7, wherein a polymer layer region in contact with the carrier layer of the value document or security document is formed from polycarbonate.

14. The method according to claim 8, wherein the carrier layer is formed from polycarbonate.

15. The method according to claim 14, wherein a printing ink used for printing the carrier layer is formed with a binding agent based on polycarbonate.

16. The method according to claim 15, wherein the polycarbonate of the printing ink is produced on the basis of a geminal disubstituted dihydroxydiphenyl cycloalkane with one or more polyols.

17. The method according to claim 3, wherein the light-sensitive film is a holography film and the first security feature is a volume hologram.

18. The method according to claim 4, wherein the light-sensitive film is a holography film and the first security feature is a volume hologram.

19. The method according to claim 3, wherein, after carrying out of method step (c), the following further method steps are carried out:
(d) bringing together of the security element with at least one polymer layer to form a layer stack, and
(e) laminating of the security element with the at least one polymer layer to form a value document or security document.

20. The method according to claim 1, wherein, after carrying out of method step (c), the following further method steps are carried out:
(d) bringing together of the security element with at least one polymer layer to form a layer stack, and
(e) laminating of the security element with the at least one polymer layer to form a value document or security document.

21. The method according to claim 19, wherein the carrier layer of the security element in the layer stack is in contact with at least one polymer layer.
